(19) United States
(12) Patent Application Publication
(10) Pub. No.: US 2019/0130422 A1
(43) Pub. Date: May 2, 2019

(54) ENHANCING TRANSACTIONAL DATA WITH RETAILER DATA AND CUSTOMER PURCHASING BEHAVIOR

(71) Applicant: Comenity LLC, Columbus, OH (US)

(72) Inventor: Tim Sweeney, Columbus, OH (US)

(73) Assignee: Comenity LLC, Columbus, OH (US)

(21) Appl. No.: 16/101,322

(22) Filed: Aug. 10, 2018

Related U.S. Application Data
(60) Provisional application No. 62/578,949, filed on Oct. 30, 2017.

(51) Int. Cl. G06Q 30/02; G06Q 20/36; H04L 29/08; G06F 17/30

(52) U.S. Cl. CPC G06Q 30/0201; G06Q 20/363; G06F 17/30554; G06F 17/30412; H04L 67/22

(57) ABSTRACT

Methods and systems for enhancing transactional data with retailer data and customer purchasing behavior are disclosed. A transactional data evaluator receives a first set of aggregated customer transaction data, having no PII and a second set of aggregated customer transaction data, having PII. The first set is compared with the second set. Each time a match is found between at least one customer in the first set of aggregated customer transaction data and the at least one customer in the second set of aggregated customer transaction data, the data is combined to form a customer wallet that includes the PII and one or more customer metrics. Based on an evaluation of the plurality of customer wallets in combination with the one or more metrics, a customer behavior presentation for the plurality of different customers is generated for a retailer.

### CROSS REFERENCE

This application claims priority to and benefit of co-pending U.S. Provisional Patent Application No. 62/578,949 filed on Oct. 30, 2017, entitled “Enhancing Transactional Data With Retailer Data” by Tim Sweeney and assigned to the assignee of the present application, the disclosure of which is hereby incorporated herein by reference in its entirety.

This application is related to co-pending U.S. patent application Ser. No. ______ filed on ______, entitled “Enhancing Transactional Data With Retailer Data” by Tim Sweeney with docket number ADS-169 and assigned to the assignee of the present application, the disclosure of which is hereby incorporated herein by reference in its entirety.

This application is related to co-pending U.S. patent application Ser. No. ______ filed on ______, entitled “Enhancing Transactional Data With Retailer Data Including Retailer-Competitor And Retailer-Non Competitor Data” by Tim Sweeney with docket number ADS-170 and assigned to the assignee of the present application, the disclosure of which is hereby incorporated herein by reference in its entirety.

### BACKGROUND

Presently, retailers and other third parties have to drive their understanding of competitive intelligence via market research such as asking customers where else they are shopping and how much they are spending. While, when asked by another party, customers are often open about where else they shop, they are also quite protective when the question changes to how much the customer spends while shopping elsewhere.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a system for enhancing transactional data with retailer data, in accordance with an embodiment.

FIG. 2A is a chart representing a partial data set in the consortium, the partial data set containing a plurality of unidentified customers, in accordance with an embodiment.

FIG. 2B is a chart representing a monthly data set of a customer x-ray for a single unidentified customer, in accordance with an embodiment.

FIG. 3A is a chart representing a partial data set in the retailer database, the partial data set containing a plurality of identified customers, in accordance with an embodiment.

FIG. 3B is a chart representing a monthly data set of a single identified customer found in the retailer database, in accordance with an embodiment.

FIG. 4 is a block diagram of a system for enhancing transactional data with retailer data using a transactional data evaluator to combine and identify spending for one or more customers, in accordance with an embodiment.

FIG. 5 is a chart of a complete customer wallet for a given customer over a certain time period, in accordance with an embodiment.

FIG. 6 is an exemplary display of a customer's spending breakdown between a retailer and any competitor(s) on a section-by-section basis, in accordance with an embodiment.

FIG. 7 is a chart of a portion of a plurality of customer wallets for a plurality of customers over a certain time period, in accordance with an embodiment.

FIG. 8 is an exemplary display of a customer's spending percentage breakdown between money spent by the customer at the retailer and money spent by the customer at any competitor(s) during a defined period, in accordance with an embodiment.

FIG. 9A is an exemplary display of a customer's spending percentage breakdown between money spent by the customer at the retailer and a total amount of money spent by the customer overall during a defined period, in accordance with an embodiment.

FIG. 9B is an exemplary display of different customer groups spending as a percentage breakdown between money spent by the number of different customer groups at the retailer and a total amount of money spent by the different customer groups overall during a defined period, in accordance with an embodiment.

FIG. 10 is a chart of a portion of a plurality of different customer metrics that could also be utilized, displayed or the like, in accordance with an embodiment.

FIG. 11 is an exemplary map showing a number of different customers their home locations, their work locations, the locations of retailers, and some exemplary distances, in accordance with an embodiment.

FIG. 12 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “determining”, “collecting”, “combining”, “prescreening”, “developing”, “presenting”, “initiating”, “resetting”, or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In general, the term “retailer” is often used to define a specific shop (e.g., the Stanley shoe shop at 1 main street) while the term “brand” defines a collection of shops (e.g., Stanley shoe shops). In the following discussion, most, if not all, of the subject matter can be appropriately applied to either or both of a retailer and a brand. Thus, to avoid confusion and for purposes of clarity, unless it is specifically pointed out otherwise in the text, the term retailer will be understood to be used for both retailer and brand.

“Share of wallet” is difficult to determine when the total amount of spending that the customer is doing is unknown. In general, share of wallet could refer to a specific customer, a collection of customers, or all customers.

In general, “share of wallet” refers to the percentage of total monies spent by the customer (a group of customers, etc.) that is spent at a given retailer and/or for a specific category/field of goods, etc. For example, a customer may spend 500 dollars on makeup at the makeup emporium and may admit to makeup emporium that they also buy makeup at Mary's. However, since the customer is unlikely to provide the amount of money they spend at Mary's, there is no way for makeup emporium to determine their share of the customer's total makeup spending budget. For example, if the customer admits to spending 100 dollars at Mary's, then makeup emporium would know they have ⅚ths of the customer's share of wallet. However, if the customer admits to spending 1000 dollars at Mary's, then makeup emporium would know they have ⅓rd of the customer's share of wallet.

In another example, a group of customers (e.g., all customers between 18-25, or any other determined portion) may spend an average of 500 dollars (for a given time period) on makeup at the makeup emporium and may admit to makeup emporium that they also buy makeup at Mary's. However, since the customers are unlikely to provide the amount of money they spend at Mary's, there is no way for makeup emporium to determine their share of the customer group's total makeup spending. For example, if the customer group admits to spending an average of 100 dollars (for the same given time period) at Mary's, then makeup emporium would know they have ⅚ths of the customer group's share of wallet. However, if the customer group admits to spending an average of 1,000 dollars (for the same given time period) at Mary's, then makeup emporium would know they have ⅓rd of the customer group's share of wallet.

Again, the retailer presently knows all about the customer's spending when the customer uses the retailer's credit account. However, the retailer does not know what other credit accounts are in the customer's wallet or the level of use of the other credit accounts by the customer. Thus, the retailer has a limited knowledge base about the customer's overall spending, spending in different areas, and percentage of spending that is done by the customer using the retailer credit account.

Importantly, the embodiments of the present invention, as will be described below, provide a capability to get a big picture view by a partnership with a credit card issuer consortium. This system and method differs significantly from the conventional market research systems. In conventional approaches, customers are asked about where they shop and how much they spend. While customers are often open about where else they shop, they are also quite protective when the question changes to how much the customer spends while shopping elsewhere.

Embodiments, as will be described and explained below in detail, provide a previously unknown procedure for enhancing transactional data with retailer data to determine a “share of wallet” for a customer or for groups of customers. For example, a consortium takes in data from a plurality of various credit account providers. The data provided by the various account is transactional data with no personally identifiable information (PII). For example, in one embodiment, the consortium receives a first credit account transactional data set from a first credit account provider and also receives at least a second credit account transactional data set from at least a second credit account provider. The consortium combines the first credit account transactional data set and the second credit account transactional data set to form the first set of aggregated customer transaction data for the first plurality of customers. The consortium then stitches together a wallet view at a customer level. Stitching the contents of the wallet together provides insight to a generic customer's purchasing patterns across a spectrum of spending instead of just being limited to the customer's purchasing patterns that are presently visible by a single credit account.

The data (with no PII) is obtained by a transactional data evaluator. The transactional data evaluator also obtains the customer transaction data (which includes PII) from a retailer database. By comparing some of the transactions that occur in the PII customer transaction data from retailer database with matching transactions (e.g., amount, date, time, location, etc.) in the no PII customer transaction data; transactional data evaluator can determine the PII for some of the received wallet view data. In the cases where the data can be matched and PII can be assigned, the specific customer's purchasing patterns across a spectrum of spending/accounts/locations, etc. can be determined. This spending/accounts/locations information is then utilized by retailers to evaluate total store performance, components or sections performance within the store (e.g., market share of tool sales versus wood sales, etc.), the percentage or ratio of different spending level customers that utilize the retailer, and the like.

Thus, embodiments of the present invention provide a streamlined system and method for enhancing transactional data with retailer data which extends well beyond what was previously done and which provides a significant improvement to the way a computer system can be used to determine retailer metrics, evaluate retailer performance (alone and in company of its peers), determine market share, and the like. The solution further provides a novel system and method that can update the retailer with updated information on a daily, weekly, monthly, or otherwise selected schedule thereby allowing the retailer to evaluate/modify/start/stop offers/incentives/sales/rewards/ and the like.

As will be described in detail, the various embodiments of the present invention do not merely implement conventional data acquisition processes on a computer. Instead, the various embodiments of the present invention, in part, provide a previously unknown procedure for enhancing transactional data with retailer data. Hence, embodiments of the present invention provide a novel process which is necessarily rooted in computer technology to overcome a problem specifically arising in the realm of retailer customer development/attraction/marketing strategies/and the like.

Moreover, the embodiments do not recite a mathematical algorithm; nor do they recite a fundamental economic or longstanding commercial practice. Instead, they address a real-world solution to the problem of providing retailers with quantized and specific information regarding retailer customer purchasing ratios.

It should be appreciated that the obtaining or accessing of customer information conforms to applicable privacy laws (e.g., federal privacy laws, state privacy laws, etc.)

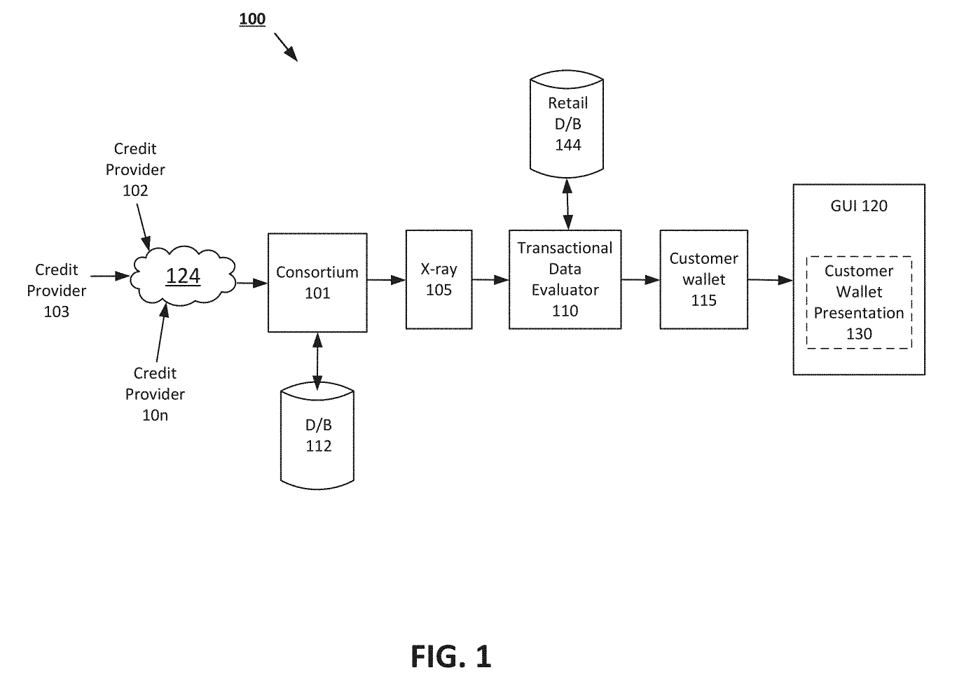

With reference now to FIG. 1, a system 100 for enhancing transactional data with retailer data is shown in accordance with an embodiment. System 100 includes credit account providers e.g., 102, 103, and 10n, network 124, consortium 101, consortium database 112, x-ray 105, transaction data evaluator 110, retailer database 144, customer wallet 115, graphical user interface 120, and customer wallet presentation 130.

The components of system 100 can be co-located or distributed and introduce the capability to provide a given retailer (or a plurality of retailers): a number of different views of the transactions of one or more retailer customers, quantified and specific retailer customer transactions at the retailer, different customer's transactions at the retailer, a ratio of customer transactions at the retailer versus the customer transactions at one or more competitors of the retailer, a ratio of customer transactions at the retailer versus the customer overall transactions for a given time period, and the like.

In one embodiment, the one or more various credit account providers e.g., 102, 103, and 10n provide credit account transaction data (or customer transaction data). For example, in one embodiment, the consortium 101 receives a first credit account transactional data set from a first credit account provider 102 and also receives at least a second credit account transactional data set from at least a second credit account provider 103. The consortium 101 combines the first credit account transactional data set and the second credit account transactional data set to form a first set of aggregated customer transaction data for the first plurality of customers.

Although, the customer transaction data will not include any PII, the customer transaction data will include identification information such as an account identifier, a customer identifier, or the like (e.g., a set of number, letters, or numbers and letters that identify a specific account without providing any PII). The identification information allows each different transaction within the customer transaction data provided by the credit account provider to be identified as one or more generic customer's transactions.

For example, in a very simplified case, credit account provider 102 provides a list of 5 customer transactions. Each of the 5 customer transactions includes a non-PII identifier. For example:
Transaction 1 identifier 623RE7
Transaction 2 identifier ABRACA
Transaction 3 identifier DABRA1
Transaction 4 identifier 623RE7
Transaction 5 identifier ABRACA

In one embodiment, any transactions that have matching identification information will be grouped into one or more generic customer accounts. For example, it can be determined that transactions 1 and 4 were from a first account, transactions 2 and 5 were from a second account, and transaction 3 was from a third account. In one embodiment, the different credit account providers will use different non-PII identifiers.

In one embodiment, each customer transaction in the customer transaction data provided by the credit account providers to consortium 101 will include information such as, but not limited to (and, in one embodiment, differing at the per transaction level, the per account level, the per credit account provider level, or the like): a retailer, a transaction location (e.g., internet/in-store), a transaction type (plastic card, digital wallet, etc.), a price, a date, a SKU (or other item identifier), a size, a description of the item purchased, etc.

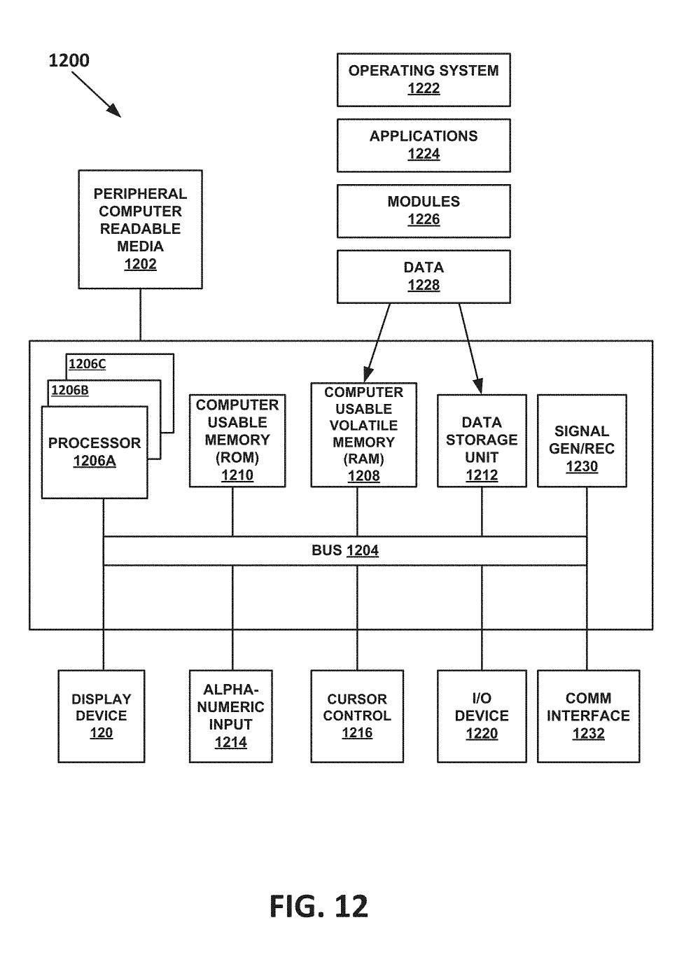

Consortium 101 is a computing system similar to the computing system described in FIG. 12. Moreover, consortium 101 can be a single machine, a virtual machine, a distributed system, a plurality of machines, or the like. In one embodiment, transactional data evaluator 110 is a component of the computing system utilized by consortium 101. In another embodiment, transactional data evaluator 110 is a completely distinct computing system (similar to the computing system described in FIG. 12) separate from consortium 101 and communicates with consortium 101 over a network such as network 124.

In one embodiment, the data received by consortium 101 is stored at database 112. In general, database 112 could be in the same location as consortium 101, remote from consortium 101, or the like. Moreover, database 112 could be in a single database or in a plurality of databases. The plurality of databases could be in a single location or in a plurality of locations including remote locations, virtual locations, and the like.

In operation, consortium 101 receives the customer transaction data from the one or more various credit account providers e.g., 102, 103, and 10n over a network 124 (such as the Internet, a secure network, local area network, and the like). Although there is no PII in the data received at consortium 101, consortium 101 can use information from the transactional data received from each of the various credit account providers (as described above) to develop a set of aggregated customer transaction data for a plurality of customers.

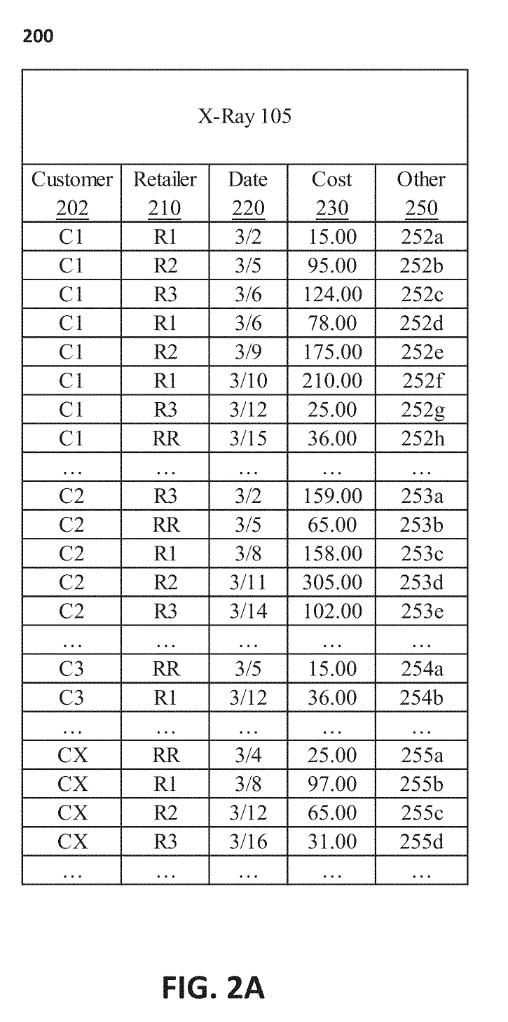

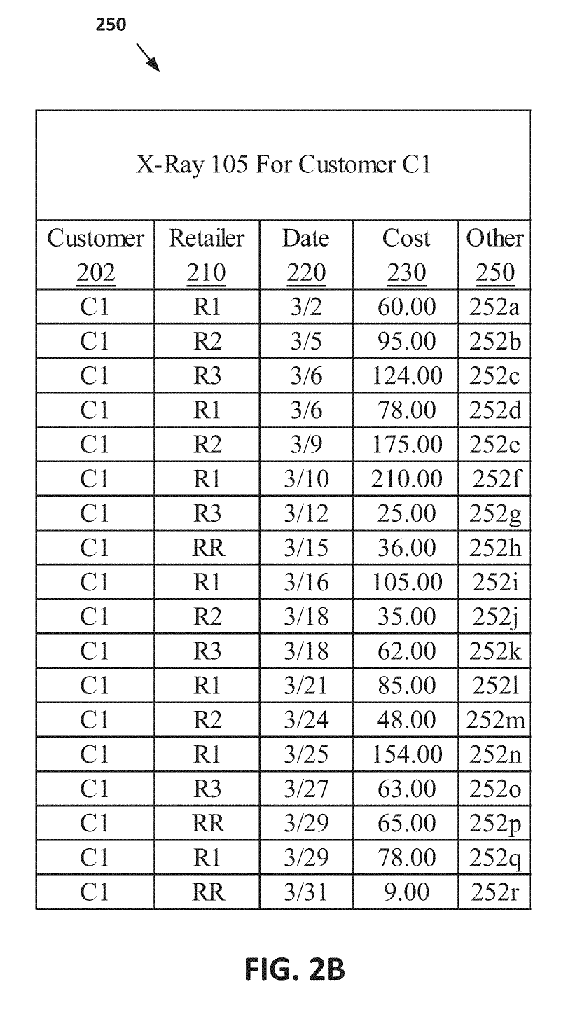

Referring now to FIG. 2A and to FIG. 1, a chart 200 representing a partial data set of aggregated customer transaction level data for at least one customer 202 (C1-CX) is shown in accordance with an embodiment. In general, the partial data set of aggregated customer transaction data (designated x-ray 105) is provided by consortium 101 and contains at least one unidentified customer 202. In one embodiment, X-ray 105 includes transaction data for each transaction, such as but not limited to, retailer 210, date 220, cost 230, and other 250. It should also be appreciated that customers would also be able to make more than one transaction on a single day.

In the following discussion, retailer 210 refers to the retailer associated with the transaction. Date 220 is a date of the transaction (it could be the date of actual occurrence of the transaction, the date of transaction recordation, a combination of the two, or the like.). Cost 230 indicates the amount spent on the transaction. Other 250 refers to other data that could be included in the customer transaction data such as, but not limited to, a transaction location (e.g., internet/in-store/address/store-identifier code, etc.), a transaction type (plastic card, digital wallet, etc.), a SKU (or other item identifier), a size, a description of the item acquired during the transaction, etc. As shown in FIG. 2A, customer 202 C1 includes other 252a-h, customer 202 C2 includes other 253a-e, customer 202 C3 includes other 254a-b, and customer 202 CX includes other 255a-d.

In general, X-ray 105 is a graphical user interface (GUI) prepared layout that can be presented by a consortium facing application. X-ray 105 presents the contents of the stitched together customer wallets and can be used to determine the retailer, the geography, and the like, e.g., anywhere the customer wallet is in use.

In one embodiment, in addition to providing a data set of aggregated customer transaction data on a per account basis as X-ray 105, consortium 101 can use the non-PII identifiers within the aggregated customer transactional data to determine that a generic customer C1 has more than one generic credit account. Once it is determined that generic customer C1 has more than one credit account (e.g., at least two generic customer accounts), the customer transaction data for every credit account identified as belonging to generic customer C1 will be aggregated into the generic customer C1 X-ray 105 to provide a multi-credit account view for generic customer C1.

In one embodiment, the plurality of generic customer C1 credit accounts could be with the same credit account provider, e.g., credit account provider 102. In another embodiment, the plurality of generic customer C1 credit accounts could include one or more accounts with two or more credit account providers (e.g., credit account provider 102, credit account provider 103, and credit account provider 10n).

In one embodiment, a determination that generic customer C1 has more than one credit account (and the determination of which credit accounts within the aggregated customer transaction data are related to C1) is based on information obtained from a credit bureau.

In another embodiment, the determination that generic customer C1 has more than one credit account (and the determination of which credit accounts within the aggregated customer transaction data are related to C1) is based on a review of the transaction data for each identified account in the aggregated customer transaction data.

For example, consortium 101 could note that generic customer C1 (associated with the account having identifier ABRACA) includes two transactions for gas at station x, a transaction for a purchase at company Alpha's lunch room, a transaction paying a phone bill for Wireswoop, two transactions at liquor-is-life market, etc.

Consortium 101 would also note that generic customer C17 (associated with the account having identifier DABRA1, from the same or a different credit account provider) includes one transaction for gas at station x, three transactions for a purchase at company Alpha's lunch room, four transactions at liquor-is-life market, etc.

Once a threshold of similar transaction histories is reached, the two or more accounts will be considered as being two or more accounts for a single generic customer C1. In this example, the transaction data from the account having identifier ABRACA will be combined (or stitched together) with the transaction data from the account having identifier DABRA1 as part of the generic customer C1's credit account portfolio.

Stitching the contents of the two accounts ABRACADABRA1 together will provide insight to a generic customer C1's purchasing patterns across a much broader spectrum of spending versus being limited to a customer C1's purchasing patterns that are presently visible by a single credit account. As such, the targeting of customer C1 for opportunities for rewards, offers, invitations, and the like will be more accurate. Moreover, as additional accounts are linked together for different generic customers (e.g., C2, C2, CX, etc.) the insight into the generic customers spending can be further expanded and provide additional opportunities for rewards, offers, invitations, and the like that could be targeted toward a number of generic customers.

Referring now to FIG. 2B, a chart 250 representing a monthly data set X-ray 105 for a single unidentified customer C1 is shown in accordance with an embodiment. Although a month is represented, it should be appreciated that the given time frame could be longer or shorter, e.g., a week, a quarter, semi-annually, a year, etc. The use of a month is merely for purposes of clarity. Moreover, although a single customer C1 is shown, it should be appreciated that the same chart 250 would be generated for other customers (e.g., C2, C3, and CX), for groups of customers, and the like.

For example, if the aggregated customer transaction data is being evaluated for customer's that made a purchase at a retailer R1, an X-ray 105 could be generated for every unidentified customer that has a transaction that indicates retailer R1. For example, as shown in FIG. 2A, all of customer C1, C2, C3 and CX have a transaction for retailer R1.

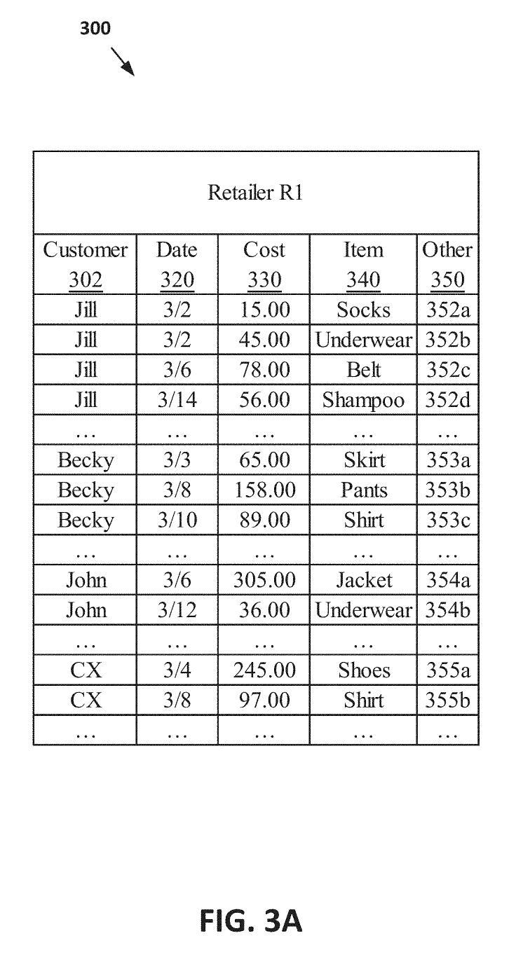

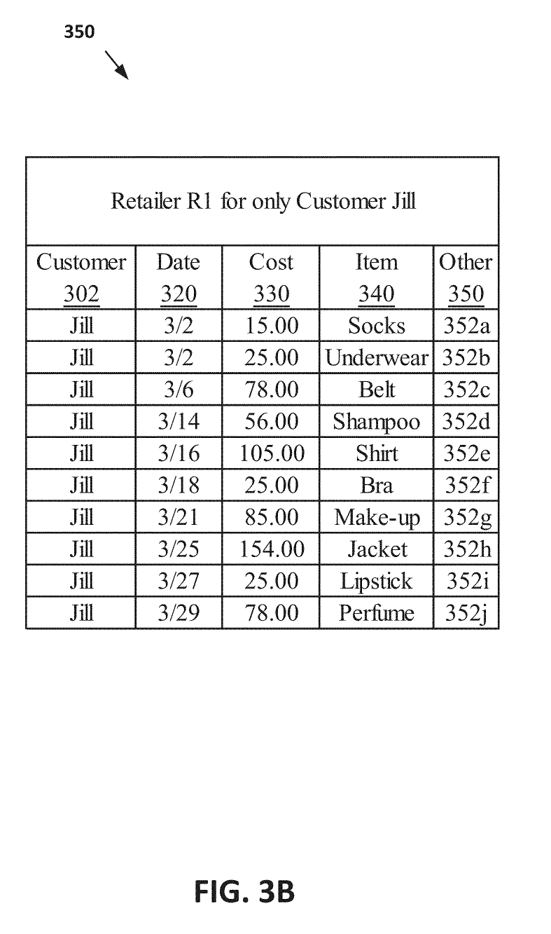

Referring now to FIG. 3A and to FIG. 1, a chart representing a partial customer transaction data set 300 from the retailer database 144 is shown. In the present example, the retailer is R1 and the partial data set includes transaction data for a customer 302, a date 320, a cost 330, an item 340 and other 350. In one embodiment, the partial data set 300 contains a plurality of identified customers Jill, Becky, John and CX. Further, the partial data set 300 includes only some of the transaction data for purposes of clarity in the discussion and Figures. In one embodiment, the actual chart could be inclusive of all customer purchases for the time period covered. In one embodiment, partial data set 300 is a GUI prepared layout that can be presented by a retailer R1.

In general, the overall transaction behavior of the at least one customer includes behaviors such as, but not limited to, every transaction by at least one customer at the retailer, every transaction by the at least one customer at the at least one competitor of the retailer, every transaction by the at least one customer at a non-competitor of the retailer, a cost of every transaction, a SKU of every transaction, a transaction date for every transaction, and the like.

Customer 302 refers to the customer associated with the transaction. Date 320 is a date of the transaction (it could be the date of actual occurrence of the transaction, the date of transaction recordation, a combination of the two, or the like.). Cost 330 indicates the amount spent on the transaction. Item 340 is a thing acquired during the transaction. Other 350 refers to other data that could be included in the customer transaction data such as, but not limited to, a transaction location (e.g., internet/in-store/address/store-identifier code, etc.), a transaction type (plastic card, digital wallet, etc.), a SKU (or other item identifier), a size, a description of the item, etc. As shown in FIG. 3A, customer 302 Jill includes other 352a-d, customer 302 Becky includes other 353a-c, customer 302 John includes other 354a-b, and customer 302 CX includes other 355a-b.

Referring now to FIG. 3B, a chart representing a monthly data set 350 of transactions for a single identified customer 302 Jill found in the retailer database 144 is shown in accordance with an embodiment. Although a month is represented, it should be appreciated that the given time frame could be longer or shorter, e.g., a week, a quarter, semi-annually, a year, etc. The use of a month is merely for purposes of clarity. Moreover, although a single customer 302 Jill is shown, it should be appreciated that the monthly data set 350 could be generated for any or all of the other customers (e.g., Becky, John, and CX).

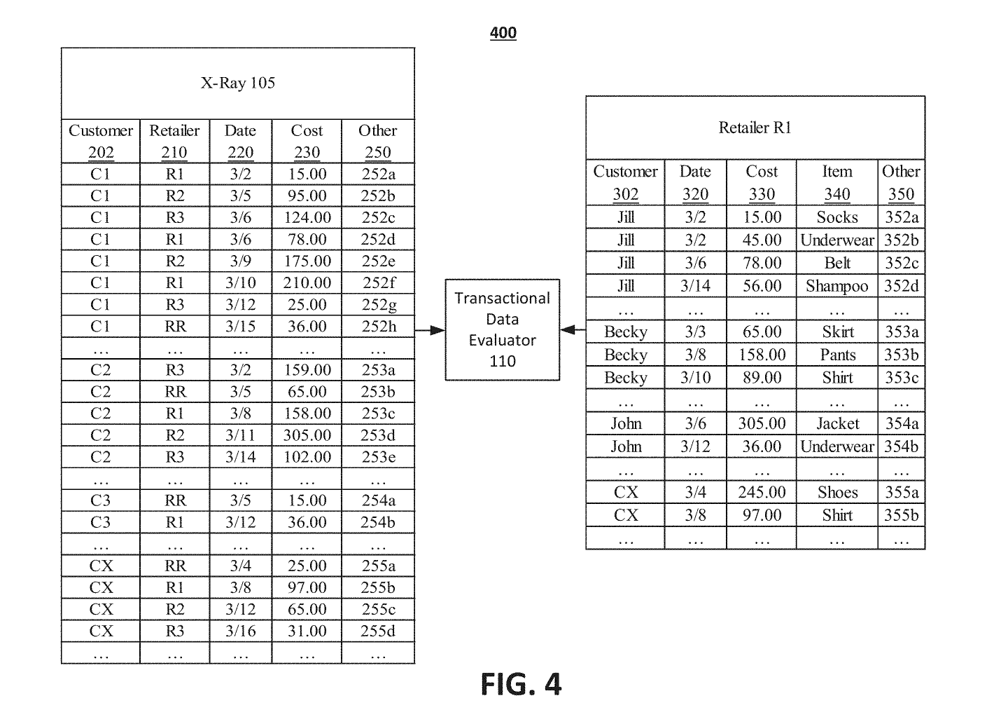

With reference now to FIG. 4 and to FIG. 1, a block diagram 400 of a method and system for enhancing the non-PII customer transaction data provided by the credit account providers to consortium 101 with retailer R1 data using transactional data evaluator 110 to combine and identify spending for one or more customers is shown in accordance with an embodiment.

For example, transactional data evaluator 110 receives the first set of aggregated customer transaction data for the first plurality of customers (e.g., X-ray 105) and also receive the second set of aggregated customer transaction data for the second plurality of customers (e.g., customer transaction data set 300). Transactional data evaluator 110 will compare the first set of aggregated customer transaction data (e.g., X-ray 105) with the second set of aggregated customer transaction data (e.g., customer transaction data set 300).

Transactional data evaluator 110 will determine a match between at least one customer in the first set of aggregated customer transaction data (e.g., X-ray 105) and the same at least one customer in the second set of aggregated customer transaction data (e.g., customer transaction data set 300) and then assign, based on the match, the PII of the second set of aggregated customer transaction data (e.g., customer transaction data set 300) for the at least one customer Jill to the matching first set of aggregated customer transaction date (e.g., X-ray 105) for the at least one customer.

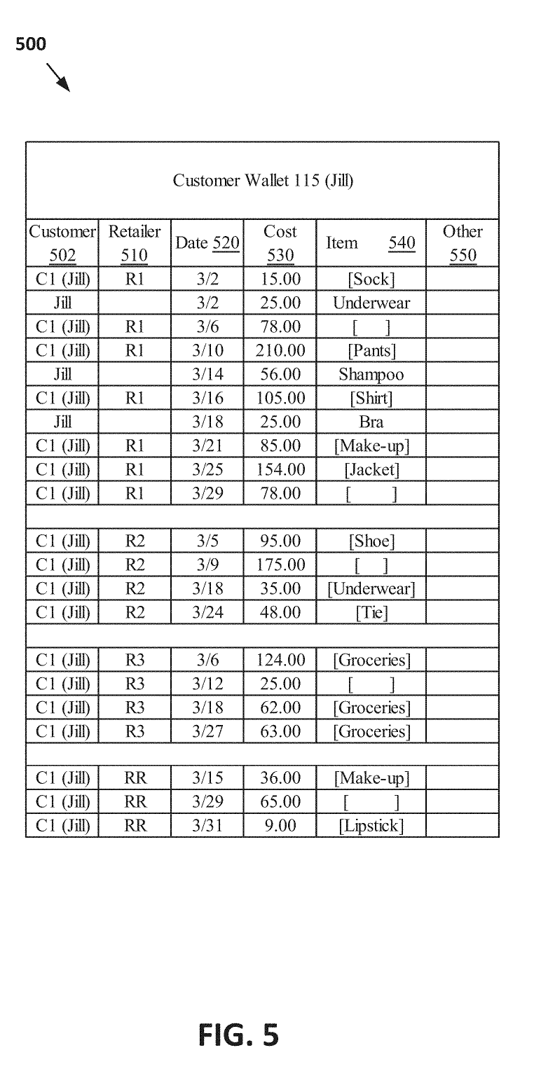

Based on the match, transactional data evaluator 110 will combine the first set of aggregated customer transaction data for the at least one customer (e.g., X-ray 105) and the second set of aggregated customer transaction data for the at least one customer (e.g., customer transaction data set 350) into a customer wallet 115 for the at least one customer Jill as shown in FIG. 5.

As such, instead of being limited to the customer's purchasing patterns that are presently visible by a retailer, such as the retailer R1 that populates retailer database 144, the transactional data evaluator 110 will use the combined data of customer wallet 115 to provide insight into a customer's purchasing patterns across a spectrum of spending.

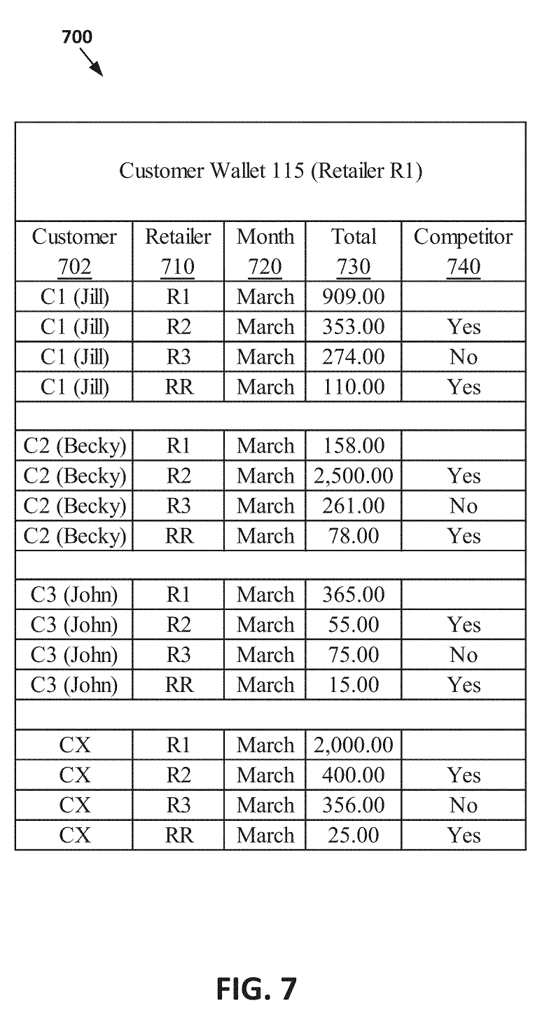

Referring now to FIG. 5, a chart 500 of a complete customer wallet 115 for a given customer Jill over a certain time period (month) is shown in accordance with an embodiment. Although a month is represented, it should be appreciated that the time frame could be longer or shorter, e.g., a week, a quarter, semi-annually, a year, etc. The use of a month is merely for purposes of clarity. Moreover, although a single customer 302 Jill is shown, it should be appreciated that the monthly customer wallet 115 could be generated for any or all of the other customers (e.g., Becky, John, CX, etc. as shown in partiality in FIG. 7). In one embodiment, customer wallet 115 includes transaction data for each transaction, such as but not limited to, customer 502, retailer 510, date 520, cost 530, item 540, and other 550.

Customer 502 refers the customer that made the transaction. In one embodiment, when customer wallet 115 (or information obtained from one or more customer wallet 115) is presented to a retailer, the customer 502 could include the PII or it could have some or all of the PII redacted. That is, although it may be determined by transaction data evaluator 110, the customer PII (e.g., information provided in customer 502 section) could be repressed (e.g., replaced with a persistent ID) when the data is presented and/or provided to the retailer. For example, instead of a customer 502 being designated as C1 (Jill), the designation could be a numerical number or other type of identifier that does not disclose any PII. In one embodiment, the information provided in the customer 502 section could be only a portion of the PII such as one or more of: a name, an address, a city, a state, a township, a gender, etc. In so doing, it should be appreciated that the disclosed PII from customer wallet 115 when presented downstream could be modifiable for privacy reasons, for legal reasons, for customer selected disclosure preferences, etc.

Retailer 510 refers to the retailer associated with the transaction. Date 520 is a date of the transaction (it could be the date of actual occurrence of the transaction, the date of transaction recordation, a combination of the two, or the like.). Cost 530 indicates the amount spent on the transaction. Item 540 is the thing acquired during the transaction. In one embodiment, the item 540 could be known as it was taken from the retailer side of the information provided to transaction data evaluator 110. In another embodiment, such as the item 540 shown in [ ] the description could be based on information obtained from X-Ray 105, or may not be found at all. As such, instead of their being actual information in the [ ] section of item 540, the section could be blank and the actual item purchased would be unknown.

Other 550 refers to other data that could be included in the customer transaction data such as, but not limited to, a transaction location (e.g., internet/in-store/address/store-identifier code, etc.), a transaction type (plastic card, digital wallet, etc.), a SKU (or other item identifier), a size, a description of the item, etc.

Referring again to FIGS. 1 and 5, transactional data evaluator 110 will generate, based on an evaluation of the customer wallet 115, quantified and specific information regarding a transaction behavior of the identified at least one customer 502 at the retailer R1. In one embodiment, the quantified and specific information is provided to retailer R1 in a visual format via GUI 120.

In one embodiment, information about customer wallet 115 as developed by transactional data evaluator 110 is provided as a customer wallet presentation 130 to provide customer specific purchasing behaviors. In one embodiment, the customer wallet presentation 130 can be shared with third parties such as, retailer partners and clients, via transactional data evaluator 110.

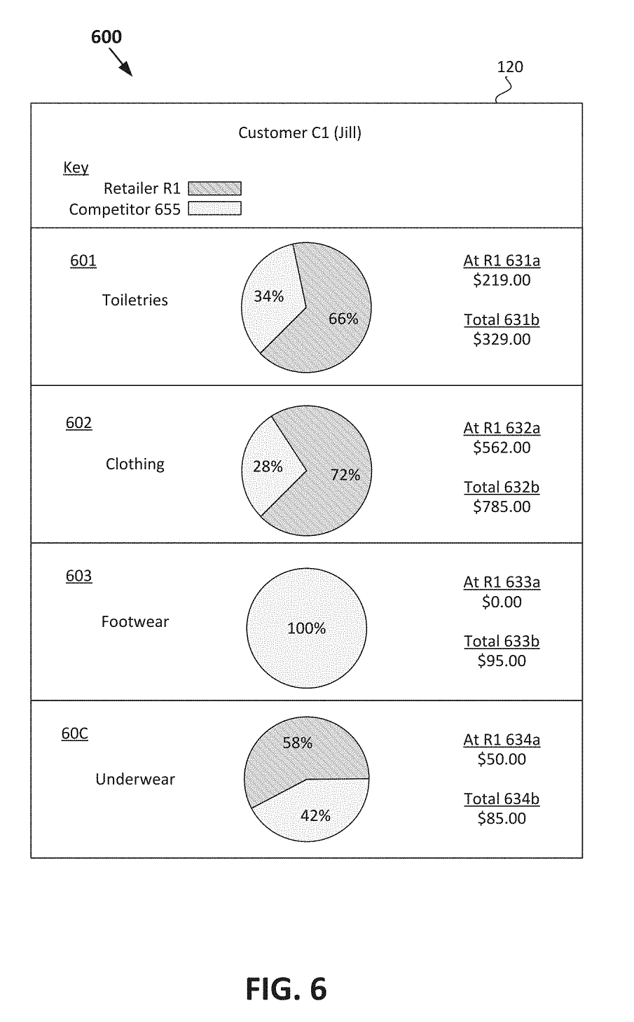

For example, utilizing the information from transactional data evaluator 110, a specific customer's transaction habits/information/history can be presented via GUI 120 to a retailer to illustrate robust customer purchasing insight. In general, transactional data evaluator 110 is able to present the data in a number of customer wallet presentation 130 formats to the underlying retailer as shown in further detail in FIGS. 6, 8, and 9A-B. The use of the charts and graphs herein is merely one of a plurality of ways, that can include, but are not limited to, pie charts, line graphs, bar graphs, spreadsheets, slide presentations, etc.

General Customer Spending Across Different Section within a Retailer

With reference now to FIG. 6 and to FIG. 1, an exemplary presentation 600 of a customer's spending breakdown between a retailer and any competitor(s) on a section-by-section basis is shown in accordance with an embodiment. For example, the customer wallet presentation 130 for retailer R1 is provided for Jill in presentation 600 which includes a toiletries section 601, a clothing section 602, a footwear section 603, and an underwear section 604.

Each of the four sections include a breakdown of Jill's spending at the specific department of retailer R1, a total amount Jill spends at all retailers for a specific department, and a pie graph representing the percentage spent at retailer R1 versus a competitor 655.

For example, at toiletries section 601, 631a shows that Jill spends $219 at R1, 631b shows the total amount $329 that Jill spends on toiletries, and the pie chart of section 601 shows that Jill buys 66% of her toiletries at retailer R1.

At clothing section 602, 632a shows that Jill spends $562 at R1, 632b shows the total amount $785 that Jill spends on clothing, and the pie chart of section 602 shows that Jill buys 72% of her clothing at retailer R1.

At footwear section 603, 633a shows that Jill spends $0 at R1, 633b shows the total amount $95 that Jill spends on footwear, and the pie chart of section 603 shows that Jill buys 100% of her footwear at a competitor 655.

Finally, at underwear section 604, 634a shows that Jill spends $50 at R1, 634b shows the total amount $85 that Jill spends on underwear, and the pie chart of section 604 shows that Jill buys 58% of her underwear at retailer R1.

Although four sections are shown in the presentation 600, it should be appreciated that the sections are exemplary. There may be more, fewer, or different sections depending upon the sections provided by retailer R1 or the sections of interest for retailer R1. Further, although only a single customer Jill is shown in the presentation 600, it should be appreciated that the data could be presented in numerous ways. There could be any number of comparison, section breakdowns, comparisons between different customers per section, and numerous other combinations, some of which are mentioned herein but many of which should be recognized as being available using the novel technology described herein.

For example, in one embodiment, again referring to FIGS. 5 and 6, the customer wallet presentation 130 presented to the retailer via GUI 120 can include a breakdown of the percentage of biggest spenders at different sections within retailer R1.

In one embodiment, the biggest spenders in a clothing section 602 could be defined as anyone spending over 600 dollars per month and the biggest spenders in the footwear section 603 could be defined as anyone spending over 300 dollars per month. In one embodiment, the data included in customer wallet presentation 130 includes a total number of customers that spent over 600 dollars per month in clothing section 602 and additionally a total number of customers that spent over 300 dollars per month at footwear section 603. The transactional data evaluator 110 can then present the ratio as part of customer wallet presentation 130 to retailer R1. By providing retailer R1 with the big spender ratio for different sections of the store, retailer R1 would be able to make operational evaluations.

For example, retailer R1 has a high percentage of the customers that spend over 600 dollars per month at clothing section 602, but a low percentage of the customers that spend over 300 dollars per month at footwear section 603. Retailer R1 would be able to use the customer wallet presentation 130 provided on GUI 120 to generate a marketing plan such as providing incentives/offers/rewards, or the like, for its clothing section 602 shoppers to use footwear section 603. Once again, since the evaluation can be repeated daily, weekly, monthly, quarterly, semi-annually, annually, and the like, retailer R1 can monitor their market position and determine if the incentives/offers/rewards, or the like are causing their share of 300 dollar per month footwear section 603 customers to grow. Similar strategies can also be developed, employed, and evaluated over time for other levels of spenders such as, average spenders, frugal spenders, and the like.

### Multi-Retailer Collaboration

Referring now to FIG. 7, a chart 700 of a portion of a customer wallet 115 for a plurality of customers over a certain time period is shown in in accordance with an embodiment. In one embodiment, the information from customer wallet 115 is evaluated by transactional data evaluator 110 to provide a factual analysis as to how much one or more customers are spending at other retailer competitors and also at other retailers that are not competitors. In other words, an overall transaction behavior comparison of the at least one customer with respect to the retailer R1 and at least one non-competitor e.g., retailer R3 of the retailer R1.

For example, presenting the information of chart 700 as a customer wallet presentation 130 to retailer R1 will allow retailer R1 to determine which other retailer 710 is not a competitor 740 and would be valuable for establishing cross-rewards, collaborative agreements, and the like.

In one embodiment, the determination of which other retailer 710 would be valuable for establishing a relationship is based on an evaluation of a plurality of customer wallets. The evaluation will include a total number of customer wallets that include transactions at either the retailer R1 or the at least one non-competitor of the retailer, e.g., R3, but do not include transactions at both the retailer R1 and the at least one non-competitor (e.g., retailer R3) of the retailer R1.

For example, a retailer R1 is a department store that has a clientele with a certain budget; In contrast, retailer R3 is a grocer, located on the other side of the parking lot from the department store R1, which has a number of clientele different that do not shop at department store R1.

If the department store R1 (or the grocer R3) determines that it is likely that customers that shop at the department store also like to get groceries and that customers that buy groceries would also likely by clothing, department store R1 and grocer R3 could develop a joint program. That is, since the department store R1 and the grocer R3 are not competitors, they could initiate a cross-rewards program that could guide (or introduce) customers from one retailer to the other.

In one embodiment, consortium 101 will provide a recommendation in the customer wallet presentation 130 to the retailer R1 to develop a cross-rewards program between retailer R1 and the at least one non-competitor of the retailer (e.g., retailer R3) for one or more of the customer wallets that include transactions at either the retailer R3 or the at least one non-competitor of the retailer (e.g., retailer R3), but do not include transactions at both the retailer R1 and the at least one non-competitor of the retailer (e.g., retailer R3).

For example, a customer wallet presentation 130 could show that 28% of grocer R3 customers shop at department store R1 and 43% of department store R1 customers use the grocer R3. This customer wallet presentation 130 would be provided to both retailers to show that both companies would be helped by cross-marketing. For example, a customer of the grocer R3 could receive an offer or coupon for the department store R1. Similarly, a customer of the department store R1 could receive an offer or coupon for grocer R3. Thus, both retailers would join together to grow their own and the other's customer base while also providing additional value to their customers. In one embodiment, the customers are account holding customers.

### Market Share

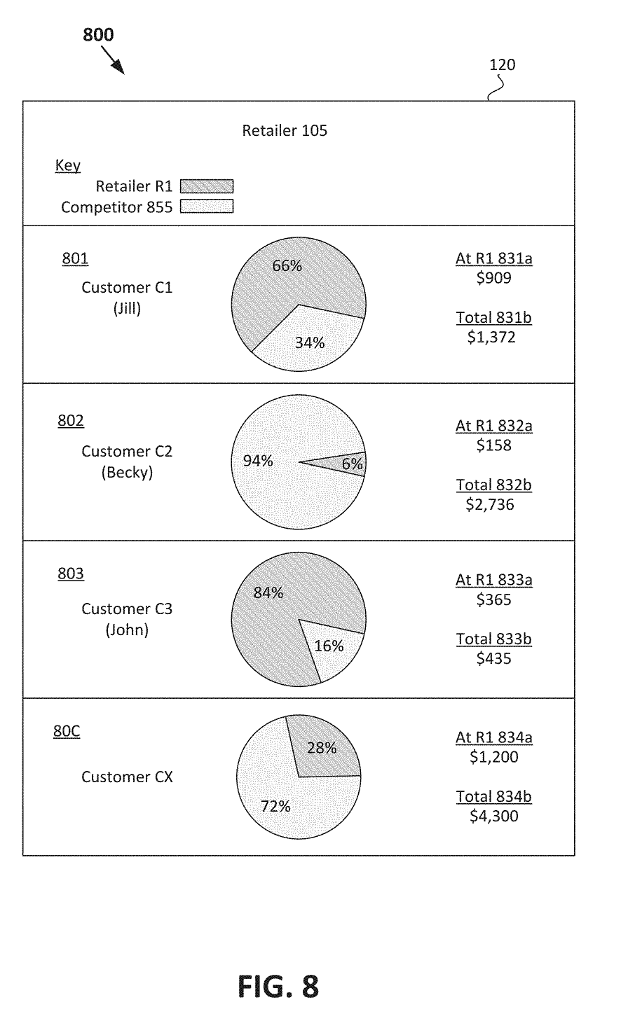

With reference now to FIG. 8, an exemplary presentation 800 of a customer's spending percentage breakdown between money spent by the customer at the retailer and money spent by the customer at any competitor(s) during a defined period is shown in accordance with an embodiment. For example, the customer wallet presentation 130 for retailer R1 in presentation 800 includes a customer C1 (Jill) section 801, a customer C2 (Becky) section 802, a customer C3 (John) section 803, and a customer CX section 804.

Each of the four sections include a breakdown of different customers spending at the retailer R1, a total amount the customers spend at all retailers in the same competitive field, and a pie graph representing the percentage spent at retailer R1 versus competitor 855 (which can include one or more different retailers within the same competing field of sales).

For example, at customer C1 (Jill) section 801, 831a shows that Jill spends $909 at retailer R1, 831b shows the total amount $1,372 that Jill spends within the field in which the retailer R1 competes, and the pie chart of section 801 shows that Jill spends 66% of her money at retailer R1.

At customer C2 (Becky) section 802, 832a shows that Becky spends $158 at retailer R1, 832b shows the total amount $2,736 that Becky spends within the field in which the retailer R1 competes, and the pie chart of section 802 shows that Becky spends 6% of her money at retailer R1.

At customer C3 (John) section 803, 833a shows that John spends $365 at retailer R1, 833b shows the total amount $435 that John spends within the field in which the retailer R1 competes, and the pie chart of section 803 shows that John spends 84% of his money at retailer R1.

Finally, at customer CX section 804, 834a shows that CX spends $1,200 at retailer R1, 834b shows the total amount $4,300 that CX spends within the field in which the retailer R1 competes, and the pie chart of section 804 shows that CX spends 28% of their money at retailer R1.

Although four customer sections are shown in presentation 800, it should be appreciated that the amount of customer sections is exemplary. There may be more, fewer, or different number of customer sections depending upon the input from retailer R1 or the customers that meet a metric established by retailer R1. Further, there could be any number of comparison, section breakdowns, comparisons between different customers per section, and numerous other combinations, some of which are mentioned herein but many of which should be recognized as being available using the novel technology described herein.

Referring still to FIG. 7 and FIG. 8, the information presented in customer wallet presentation 130 can include a breakdown of the percentage of biggest spenders in a given retailers field. For example, the biggest spenders in a given field could be defined as anyone spending over 1,000 (or any selected amount) dollars per month. The data presented in customer wallet presentation 130 would include a total number of customers within the underlying customer wallet 115 that spent over 1,000 dollars in the field (e.g., Jill, Becky and CX). By providing the retailer with the big spender ratio, the retailer would be able to make operational evaluations.

For example, if the ratio is a high number in the retailer's favor, e.g., 500 big spenders in total, 410 of them use the retailer's credit account or shop at the retailer stores; the retailer would be aware they are on the right marketing track and could keep going forward in a similar fashion. Further, since the evaluation can be repeated daily, weekly, monthly, quarterly, semi-annually, annually, and the like, the retailer could monitor their market saturation and continue to maintain their position by making marketing adjustments and then looking at the results over a selected period of time to ensure that the marketing is working and that they are maintaining their market share.

In contrast, if the ratio is a low number in the retailer's favor, e.g., 500 big spenders in total, 40 of them use the retailer's credit account or shop at the retailer's stores; the retailer would be aware of their low market saturation and would work harder or adjust their strategy for market penetration. For example, the retailer could initiate or improve a rewards/incentive/offer scenario to try and draw more big spenders. Further, since the evaluation can be repeated daily, weekly, monthly, quarterly, semi-annually, annually, and the like, the retailer could monitor their market saturation and continue to adjust the marketing by increasing aspects that work and stopping aspects that do not.

Similar strategies can also be developed, employed, and evaluated over time for other levels of spenders such as, average spenders, frugal spenders, and the like.

### Specific Customer Spending at a Specific Retailer Versus Total Spending in the Field

With reference still to FIG. 7 and FIG. 8, in one embodiment, the information presented to retailer R1 can include the total amount of the customer's wallet 115 being spent in a specific field versus a percentage of the customer's wallet being spent at retailer R1. By knowing the total amount of the customer's wallet being spent in a specific field in combination with the percentage of the customer's wallet that is being spent at the specific retailer, the retailer would be able to determine customer specific courses of action.

In one embodiment, the information presented in customer wallet presentation 130 includes a recommendation to the retailer R1 for a reward action for said at least one customer, the recommendation generated using a first weighting based on the total amount of money spent by the at least one customer in the field of the retailer for the given time frame, and at least a second weighting based on a result of the comparison of what the at least one customer is spending at the retailer for the given time frame versus what the at least one customer is spending at the at least one competitor of the retailer for the given time frame.

For example, customer C3 (John) section 803, the percentage of John's wallet that is being spent at retailer R1 is 84% and the total amount of John's wallet being spent in the specific field is $435.00. The retailer would determine a rewards/incentive/offer scenario that was built on the underlying fact that, at best, there are only $70 additional dollars to be gained from John. As such, the retailer would provide a low amount, e.g., 0-1 dollars to be allocated to advertising/offers/incentives directed to John.

In a second example, customer C1 (Jill) section 801, the percentage of Jill's wallet that is being spent at the specific retailer is 66% and the total amount of Jill's wallet being spent in the specific field is $1,372. The retailer would determine a rewards/incentive/offer scenario that was built on the underlying fact that, at best, there are $463 additional dollars to be gained from Jill. As such, the retailer would provide a medium amount, e.g., 5-20 dollars to be allocated to advertising/offers/incentives directed to Jill. In one embodiment, the allocated amount could be raised or lowered based on customer loyalty. For example, since Jill spends 66% of her total wallet in the given field at retailer R1, it would be likely that Jill would be inclined, with the right offer, to spend more at retailer R1.

In a third example, customer CX section 804, the percentage of CX's wallet that is being spent at the specific retailer is 28% and the total amount of CX's wallet being spent in the specific field is $4,300. The retailer would determine a rewards/incentive/offer scenario that was built on the underlying fact that, presently, there are $3,100 additional dollars to be gained from CX. As such, the retailer would provide a larger amount, e.g., 20-50 dollars, to be allocated to advertising/offers/incentives directed to CX. In one embodiment, the allocated amount could be raised or lowered based on customer loyalty. For example, since spends 28% of the total wallet at the retailer, it would be uncertain that customer CX would be inclined, with the right offer, to spend more of the total wallet amount at the retailer.

In a fourth example, customer C2 (Becky) section 802, the percentage of Becky's wallet that is being spent at the specific retailer is 6% and the total amount of Becky's wallet being spent in the specific field is $2,736. The retailer would determine a rewards/incentive/offer scenario that was built on the underlying fact that, presently, there are $2,578 additional dollars to be gained from Becky. As such, the retailer would provide a larger amount, e.g., 20-50 dollars, to be allocated to advertising/offers/incentives directed to Becky.

Of course, it should be appreciated that the examples described herein are exemplary. The amount that a retailer would spend for advertising/offer/reward could be similar to the above, or different from the above. For example, a retailer may spend more on a low percentage customer to try and turn the customer into a high percentage customer. In another scenario, the retailer may spend more on a high percentage customer for loyalty reasons. Regardless of how the retailer chooses to use the information, the ability of the retailer to develop a personalized plan at a per-customer level would be of significant importance. It would reduce the retailer advertising into the dark, and allow them to instead focus on specific customers, specific customer behaviors, and the like.

### Specific Customer Spending at a Specific Retailer Versus Total Money Spent

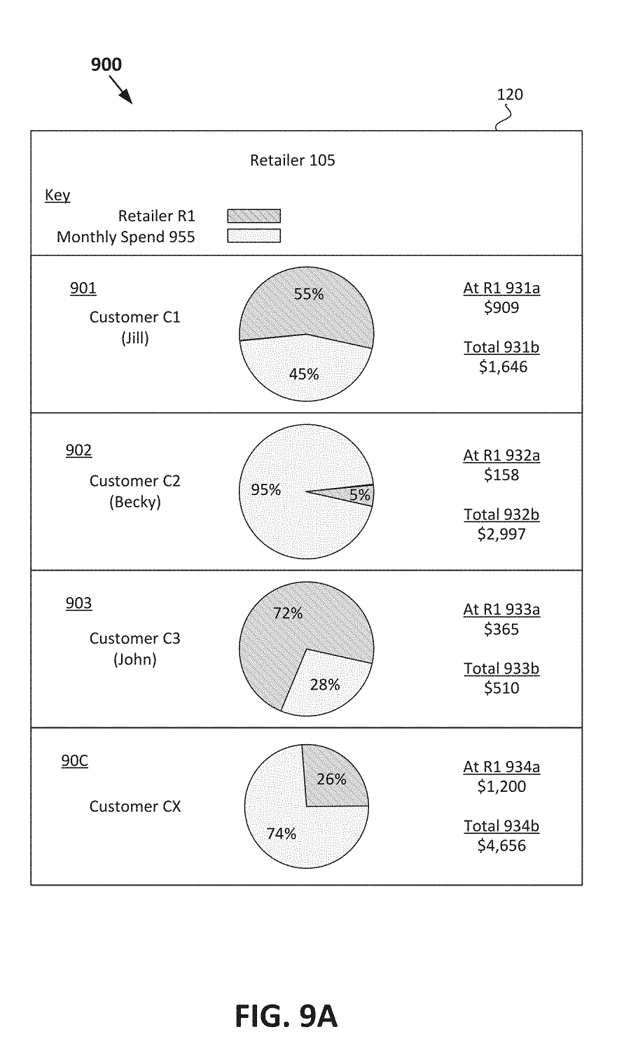

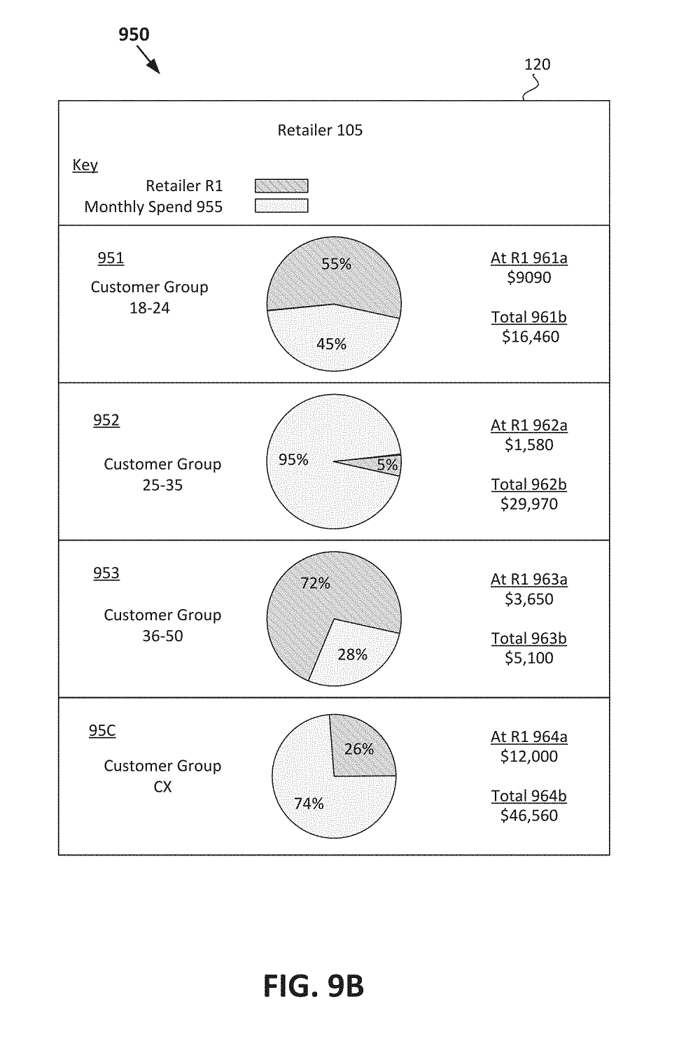

Referring now to FIG. 9A, an exemplary presentation 900 of a customer's spending percentage breakdown between money spent by the customer at retailer R1 and a total amount of money spent by the customer overall during a defined period (e.g., monthly spend 955) is shown in accordance with an embodiment. For example, the customer wallet presentation 130 for retailer R1 in presentation 900 includes a customer C1 (Jill) section 901, a customer C2 (Becky) section 902, a customer C3 (John) section 903, and a customer CX section 904.

Each of the four sections include a breakdown of different customers spending at the retailer R1, a total amount the customers spend over the total time period, and a pie graph representing the percentage spent at retailer R1 versus monthly spend 955.

In one embodiment, the information presented in customer wallet presentation 130 includes a recommendation to the retailer for a reward action for said at least one customer, the recommendation generated using a first weighting based on the total amount of money spent by the at least one customer at retailer R1 over the given time frame compared to what the at least one customer is spending over the given time frame.

For example, at customer C1 (Jill) section 901, 931a shows that Jill spends $909 at retailer R1, 931b shows the total amount $1,646 of Jill's monthly spend 955, and the pie chart of section 901 shows that Jill spends 55% of her monthly spend 955 at retailer R1.

At customer C2 (Becky) section 902, 932a shows that Becky spends $158 at retailer R1, 932b shows the total amount $2,997 of Becky's monthly spend 955, and the pie chart of section 902 shows that Becky spends 5% of her monthly spend 955 at retailer R1.

At customer C3 (John) section 903, 933a shows that John spends $365 at retailer R1, 933b shows the total amount $510 of John's monthly spend 955, and the pie chart of section 903 shows that John spends 72% of his monthly spend 955 at retailer R1.

Finally, at customer CX section 90C, 934a shows that CX spends $1,200 at retailer R1, 934b shows the total amount $4,656 of CX's monthly spend 955, and the pie chart of section 904 shows that CX spends 26% of their monthly spend 955 at retailer R1.

Although four customer sections are shown in presentation 900, it should be appreciated that the amount of customer sections is exemplary. There may be more, fewer, or different number of customer sections depending upon the input from retailer R1 or the customers that meet a metric established by retailer R1. Further, there could be any number of comparison, section breakdowns, comparisons between different customers per section, and numerous other combinations, some of which are mentioned herein but many of which should be recognized as being available using the novel technology described herein. Moreover, although a month of spending is shown, it should be appreciated that the length of time could be longer or shorter, e.g., a week, quarterly, yearly, and the like.

For example, as shown in FIG. 9B, an exemplary presentation 950 of a breakdown similar to exemplary presentation 900, except instead of individual customers, the presentation is broken down in different customer groupings (in this case based on age, but the groupings could be based on different age ranges, gender, parent, non-parent, annual earnings, where customers live, where customers work, and the like).

In one embodiment, exemplary presentation 950 shows different customer groups spending as a percentage breakdown between money spent by the number of different customer groups at retailer R1 and a total amount of money spent by the different customer groups overall during a defined period (e.g., monthly spend 955) in accordance with an embodiment. For example, the different customer groups in presentation 950 includes a customer group 18-24 section 951, a customer group 25-35 section 952, a customer group 36-50 section 953, and a customer group CX section 954. Although presentation 950 shows a breakdown based on customer age, it should be appreciated that 950 is one example of a breakdown. The information could be broken down into other aspects such as, different age brackets, gender, parent, non-parent, annual earnings, where customers live, where customers work, etc.

Each of the four sections include a breakdown of different customer group's spending at the retailer R1 versus a total amount the different customer groups spend over the total time period, and a pie graph to visually represent the percentage spent at retailer R1 versus monthly spend 955.

In one embodiment, the information presented in customer wallet presentation 130 includes a recommendation to the retailer for a reward action for one or more of the different customer groups, the recommendation generated using a first weighting based on the total amount of money spent by each of the at least one of the different customer groups at retailer R1 over the given time frame versus what each of the at least one different customer groups are spending in total over the given time frame.

For example, at customer group 18-24 section 951, 961a shows that customer group 18-24 spends $9,090 at retailer R1, 961b shows the total amount $16,460 of customer group 18-24 monthly spend 955, and the pie chart of section 951 shows that customer group 18-24 spends 55% of their monthly spend 955 at retailer R1.

At customer group 25-35 section 952, 962a shows that customer group 25-35 spends $1,580 at retailer R1, 962b shows the total amount $29,970 of customer group 25-35 monthly spend 955, and the pie chart of section 952 shows that customer group 25-35 spends 5% of their monthly spend 955 at retailer R1.

At customer group 36-50 section 953, 963a shows that customer group 36-50 spends $3,650 at retailer R1, 963b shows the total amount $5,100 of customer group 36-50 monthly spend 955, and the pie chart of section 953 shows that customer group 36-50 spends 72% of their monthly spend 955 at retailer R1.

Finally, at customer group CX section 95C, 964a shows that customer group CX spends $12,000 at retailer R1, 964b shows the total amount $46,560 of customer group CX monthly spend 955, and the pie chart of section 95C shows that customer group CX spends 26% of their monthly spend 955 at retailer R1.

Similar to the discussions above, by knowing the total amount of the customer's wallet being spent per measured period in combination with the percentage of the customer's wallet that is being spent at the specific retailer, retailer R1 would be able to determine customer specific courses of action. The actions can include big spender determination, marketing determinations, and the like.

For example, from the above description, it should be noted that the information would likely show that retailer R1 is missing some significant spending in customer group 25-35 section 952 and customer group CX section 954. As such, there could be a recommendation to adjust the advertising campaign, offers, rewards, etc. to entice customer group 25-35 section 952 and/or customer group CX section 954.

### Additional Aspects

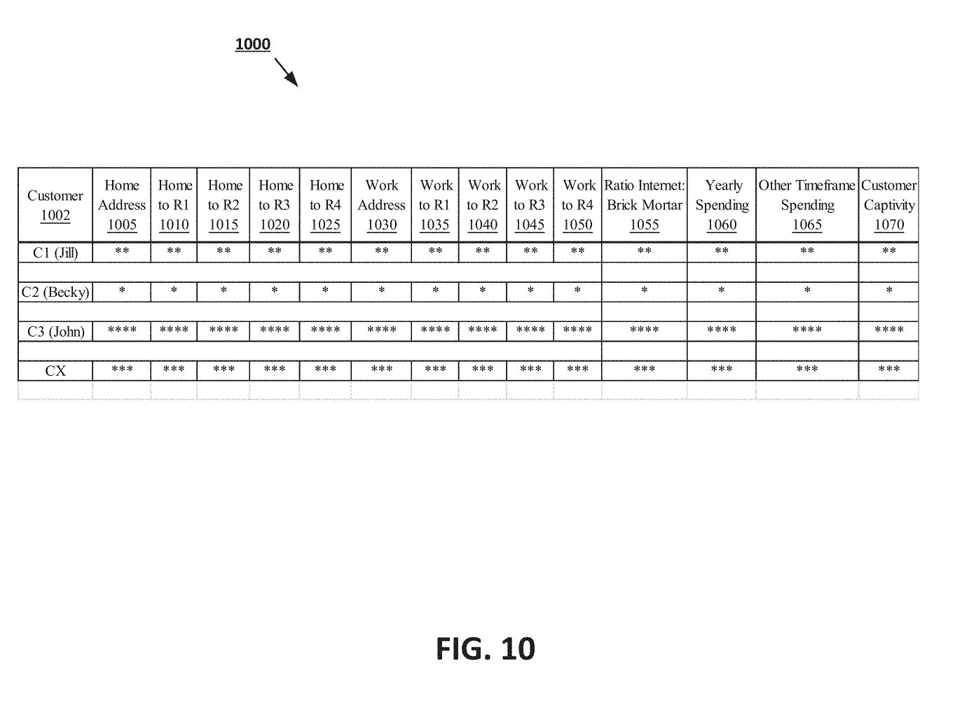

Referring now to FIG. 10, a chart 1000 of a portion of a plurality of different customer metrics that could also be utilized, displayed or the like is shown in accordance with an embodiment. The different customer metrics can include, but are not limited to, at least one customer 1002 (customer C1, C2, C3, and CX are shown), a home address 1005 for each customer, a distance from a home of each customer to the retailer R1 1010, a distance from home of each customer to R2 1015, a distance from home of each customer to R3 1020, a distance from home of each customer to R4 1025, a work address 1030 of each customer, a distance from a work location of each customer to the retailer R1 1035, a distance from work of each customer to R2 1040, a distance from work of each customer to R3 1045, a distance from work of each customer to R4 1050, which of the every transaction by said identified customer was made via an online transaction, which of the every transaction by said identified customer was made via an in-store transaction (in one embodiment shown as ratio Internet:brick Mortar 1055), yearly spending 1060, other timeframe spending 1065, a customer captivity 1070 rating, or the like.

In one embodiment, the additional customer metrics can be provided by the transaction data evaluator 110 to the retailer R1 as a customer behavior presentation portion in customer wallet presentation 130. The aspects can include channel shoppers, e.g., does the customer spend more shopping online or spend more shopping in a brick-and-mortar store. In one embodiment, the aspects can include a break down such as a percentage of transactions, for each of the plurality of customers, which occurred at a brick-and-mortar store, a break down such as a percentage of transactions, for each of the plurality of customers, that occurred online, and the like. Although percentage is discussed, it could also be presented graphically, such as a pie chart, as a ratio, as a bar graph, etc.

Aspects can also include the customer's total spending level. The spending level could be only for brick-and-mortar spending, only for online spending, or for the combination of both brick-and-mortar and online spending. For example, each customer in the group of customers can be grouped (or assigned) into one of a larger than average spender group (e.g., spend more than 50,000 retail dollars per year), an average spender group (e.g., spend more than 20,000 retail dollars per year), a less than average spender group (e.g., spend less than 10,000 retail dollars per year), and the like. Of course, it should be appreciated that the amounts for each group could differ. The use of specific values herein is provided merely for purposes of example. Moreover, the group assignment could be only for brick-and-mortar spending, only for online spending, or for the combination of both brick-and-mortar and online spending.

By using one or more of the additional metrics, the customer groupings, ratios and/or percentages of spending can be moved into and out of different customer groups. For example, larger than average spending customers that spend their retail dollars mostly online may not be included (or may be flagged) in the data set of a larger than average spending customers of retail dollars in brick-and-mortar stores. Thus, if retailer R1 wishes to focus on specific areas, e.g., online or brick-and-mortar store sales, the data can be so parsed.

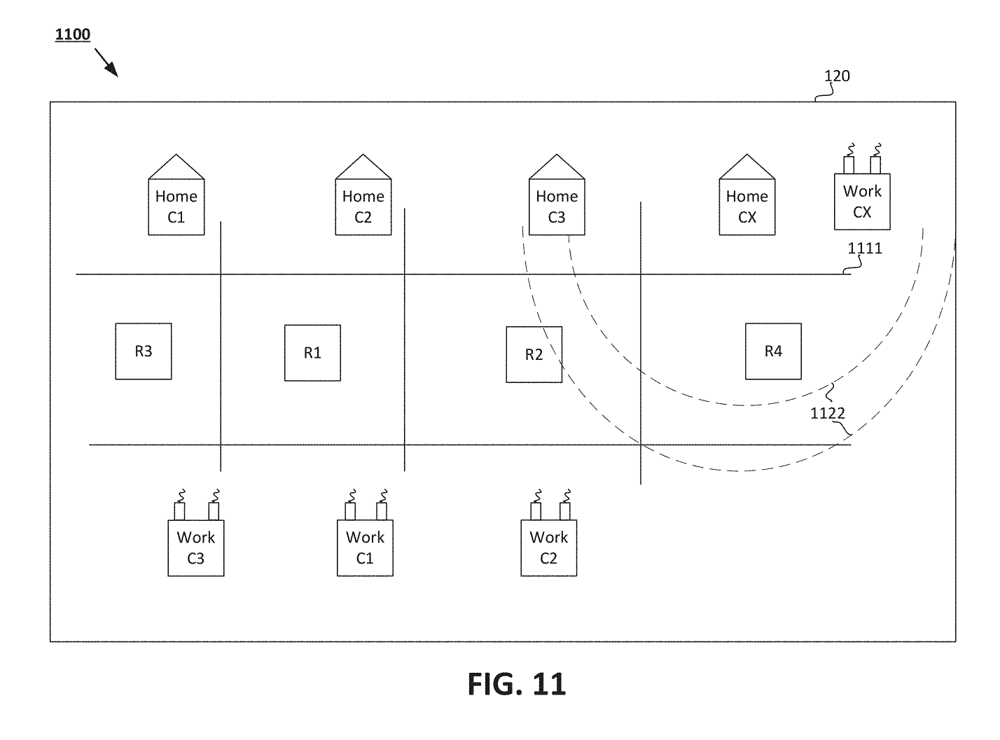

With reference now to FIG. 11, an exemplary map 1100 showing a number of different customers (e.g., customers C1, C2, C3, and CX) their home locations, their work locations, the locations of retailers R1, R2, R3, and R4, and some exemplary distances are shown in accordance with an embodiment. Although the locations of the stores are shown as R1, R2, R3, and R4, they are exemplary. It could be appreciated that the locations of stores could be malls, shopping areas, etc. further, there may be more than one of R1, R2, R3, and R4 on the map 1100. However, for purposes of clarity, the R1, R2, R3, and R4, work and home locations are provided in a simplified fashion to avoid cluttering the map 1100. However, it should be appreciated that map 1100 representing an actual neighborhood, city, county, or other area would likely include significantly more detail, housing, roads, etc.

In one embodiment, map 1100 is a customer behavior presentation. In another embodiment, chart 1000 and map 1100 would both be part of the customer behavior presentation. Although two examples of a customer behavior presentation are shown, it should be appreciated that the customer behavior presentation could include more or fewer pages, different information, higher or lower levels of granularity, etc. The use of FIGS. 10 and 11 herein are provided for purposes of representing possible examples of the data that could be included in the customer behavior presentation (e.g., a customer wallet presentation 130).

In general, exemplary map 1100 shows a plurality of customer's homes (e.g., home C1, home C2, home C3, and home CX), a plurality of customer's work locations (e.g., Work C1, Work C2, Work C3, and Work CX), a plurality of retailers and their locations (e.g., R1, R2, R3, and R4), and a number of roads 1111. From map 1100 in combination with the data of chart 1000, a large amount of the previously unattainable information can be presented in a user friendly manner on a GUI 120.

For example, assume that the data presented on map 1100 correlates with the data of chart 1000 and this customer behavior presentation (a part of customer wallet presentation 130) is being presented on GUI 120 to retailer R1. If the data found in any or all of FIGS. 2A-9B showed that customer CX did not make many transactions (or spend a lot of money) at R1 (but did make a lot of transactions (or spend a lot of money at R4), the information used by transactional data evaluator 110 to generate chart 1000 and map 1100 would provide visual evidence and/or marketing suggestions that would be useful to retailer R1. Specifically, the information would likely guide retailer R1 away from spending a lot of time, effort, or money in trying to obtain the business of customer CX. Especially if customer CX was in a less than average spender group, or an average spender group. Even, if customer CX was in a larger than average spender group, it is likely that retailer R1 (or retailer R3) would be hard pressed to obtain customer CX business since customer CX works and lives on the other side of town.

Moreover, if customer CX's spending history shows that customer CX does not travel more than a 3-5 miles radius 1122 from their own home to make any transactions. In one embodiment, retailer R1 would utilize that travel radius 1122 information as a weighted factor; possibly with even more weight than the yearly spending 1060 of customer CX, when determining whether or not customer CX should receive any offers or rewards.

For example, since retailer R1 is well outside or radius 1122, it would be statistically unlikely that customer CX would make the trip to retailer R1 and as such, the marketing monies may be better spent elsewhere. In contrast, if retailer R2 where receiving the presentation, and noted that competitor R4 received most of the transactions from customer CX; since retailer R2 is close to and/or partially within the 3-5 mile radius 1122, the weighted factor of customer CX travel radius 1122 would be in the favor of retailer R2 spending marketing monies on customer CX.

In another example, if the data found/generated/presented in any or all of FIGS. 2A-9B showed that customer C1 did not make many transactions (or spend a lot of money) at R1 (but did make a lot of transactions (or spend a lot of money at R2 and R4), the information used by transactional data evaluator 110 to generate chart 1000 and map 1100 would provide visual evidence and/or marketing suggestions that would again be useful to retailer R1. For example, it can be seen from map 1100 that customer C1 travels past retailer R1 on the way to work and on the way home from work. It is also apparent from map 1100 that customer C1 would pass by retailer R1 on the way from home to make transactions at retailer R2. Thus, the information determined by transactional data evaluator 110 and provided in the customer behavior presentation (a part of customer wallet presentation 130) would likely guide retailer R1 to spend some time, effort, and/or money in trying to obtain the business of customer C1 regardless of the spending group of customer C1.

However, if customer C1 was in the average spender group, or the larger than average spender group transactional data evaluator 110 could provide additional guidance as to obtaining the business of customer C1. The additional guidance could be in the form of the time of day that customer C1 makes the most transactions, e.g., does customer C1 make the most transactions during working hours or on weekends, when does customer C1 make the biggest transactions (e.g., during working hours or on weekends), etc. By providing this additional information in the customer behavior presentation (a part of customer wallet presentation 130) retailer R1 would be able to determine what type of coupons or offers to provide, e.g., time of day, day of week, etc.

In one embodiment, customer captivity 1070 is also evaluated and that metric utilized to drive retailer actions. In general, a customer is considered captive if they spend more than a certain percentage of their wallet in total, or in a given field, at a given retailer. For example, assume 80% is the amount that is considered customer captivity 1070. If customer C3 (John) spends 80% of their grocery money at grocery retailer R3, grocery retailer R3 would consider John to be “captive”. As such, grocery retailer R3 could choose to not provide any incentives/offers/or the like above that which they already provide to John. In contrast, if customer C2 (Becky) spends only 30% of their total grocery budget at grocery retailer R3, then grocery retailer R3 would evaluate the metric and decide if sending Becky some offers/deals/coupons/etc. would raise the percentage of Becky's spending at grocery retailer R3.

Further, since the evaluation can be repeated as a yearly spending 1060, or at another timeframe spending 1065 such as daily, weekly, monthly, quarterly, semi-annually, and the like, the retailer could monitor their marketing results on Becky (30%) and make adjustments to the marketing strategy by using the updated feedback to increase marketing aspects that work and reduce or stop marketing aspects that are not working.

In another example, if customer C1 (Jill) spends 95% of her total wallet at motorcycle shop retailer M, motorcycle shop retailer M would consider customer Jill to be “captive”. As such, motorcycle shop retailer M could choose to provide very few if any incentives/offers/or the like, above that which they already provide to customer Jill. In contrast, if customer CX spends only 43% of their total wallet at motorcycle shop retailer M, then motorcycle shop retailer M would see the customer behavior presentation (a part of customer wallet presentation 130) and be advised/or determine if sending customer CX offers/deals/coupons/etc. would raise the percentage of customer CX's spending at motorcycle shop retailer M.

Again, since the evaluation can be repeated as a yearly spending 1060, or at another timeframe spending 1065 such as daily, weekly, monthly, quarterly, semi-annually, and the like, the retailer M could monitor their marketing results on customer CX and make adjustments to the marketing strategy by using the new feedback to increase marketing aspects that work and reduce or stop marketing aspects that did not. Moreover, if a customer Q with a similar profile as customer CX was identified, transactional data evaluator 110 would suggest that retailer M use the marketing lessons learned on customer CX to guide the marketing for obtaining transactions from customer Q.

### Example Computer System Environment

With reference now to FIG. 12, portions of the technology for providing a communication composed of computer-readable and computer-executable instructions that reside, for example, in non-transitory computer-readable storage media (e.g., non-transitory computer readable medium) of a computer system. That is, FIG. 12 illustrates one example of a type of computer that can be used to implement embodiments of the present technology. FIG. 12 represents a system or components that may be used in conjunction with aspects of the present technology. In one embodiment, some or all of the components described herein may be combined with some or all of the components of FIG. 12 to practice the present technology.

FIG. 12 illustrates an example computer system 1200 used in accordance with embodiments of the present technology. It is appreciated that system 1200 of FIG. 12 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 12, computer system 1200 of FIG. 12 is well adapted to having peripheral computer readable media 1202 such as, for example, a disk, a compact disc, a flash drive, and the like coupled thereto.

Computer system 1200 of FIG. 12 includes an address/data/control bus 1204 for communicating information, and a processor 1206A coupled to bus 1204 for processing information and instructions. As depicted in FIG. 12, system 1200 is also well suited to a multi-processor environment in which a plurality of processors 1206A, 1206B, and 1206C are present. Conversely, system 1200 is also well suited to having a single processor such as, for example, processor 1206A. Processors 1206A, 1206B, and 1206C may be any of various types of microprocessors. Computer system 1200 also includes data storage features such as a computer usable volatile memory 1208, e.g., random access memory (RAM), coupled to bus 1204 for storing information and instructions for processors 1206A, 1206B, and 1206C.

System 1200 also includes computer usable non-volatile memory 1210, e.g., read only memory (ROM), coupled to bus 1204 for storing static information and instructions for processors 1206A, 1206B, and 1206C. Also present in system 1200 is a data storage unit 1212 (e.g., a magnetic disk drive, optical disk drive, solid state drive (SSD), and the like) coupled to bus 1204 for storing information and instructions. Computer system 1200 also includes an optional alpha-numeric input device 1214 including alphanumeric and function keys coupled to bus 1204 for communicating information and command selections to processor 1206A or processors 1206A, 1206B, and 1206C. Computer system 1200 also includes an optional cursor control device 1216 coupled to bus 1204 for communicating user input information and command selections to processor 1206A or processors 1206A, 1206B, and 1206C. Optional cursor control device may be a touch sensor, gesture recognition device, and the like. Computer system 1200 of the present embodiment also includes GUI 120 coupled to bus 1204 for displaying information.

Referring still to FIG. 12, GUI 120 of FIG. 12 may be a liquid crystal device, cathode ray tube, OLED, plasma display device or other display device suitable for creating graphic images and alpha-numeric characters recognizable to a user. Optional cursor control device 1216 allows the computer user to dynamically signal the movement of a visible symbol (cursor) on GUI 120. Many implementations of cursor control device 1216 are known in the art including a trackball, mouse, touch pad, joystick, non-contact input, gesture recognition, voice commands, bio recognition, and the like. In addition, special keys on alpha-numeric input device 1214 capable of signaling movement of a given direction or manner of displacement. Alternatively, it will be appreciated that a cursor can be directed and/or activated via input from alpha-numeric input device 1214 using special keys and key sequence commands.

System 1200 is also well suited to having a cursor directed by other means such as, for example, voice commands. Computer system 1200 also includes an I/O device 1220 for coupling system 1200 with external entities. For example, in one embodiment, I/O device 1220 is a modem for enabling wired or wireless communications between system 1200 and an external network such as, but not limited to, the Internet or intranet. A more detailed discussion of the present technology is found below.

Referring still to FIG. 12, various other components are depicted for system 1200. Specifically, when present, an operating system 1222, applications 1224, modules 1226, and data 1228 are shown as typically residing in one or some combination of computer usable volatile memory 1208, e.g. random access memory (RAM), and data storage unit 1212. However, it is appreciated that in some embodiments, operating system 1222 may be stored in other locations such as on a network or on a flash drive; and that further, operating system 1222 may be accessed from a remote location via, for example, a coupling to the internet. In one embodiment, the present technology, for example, is stored as an application 1224 or module 1226 in memory locations within RAM 1208 and memory areas within data storage unit 1212. The present technology may be applied to one or more elements of described system 1200.

System 1200 also includes one or more signal generating and receiving device(s) 1230 coupled with bus 1204 for enabling system 1200 to interface with other electronic devices and computer systems. Signal generating and receiving device(s) 1230 of the present embodiment may include wired serial adaptors, modems, and network adaptors, wireless modems, and wireless network adaptors, and other such communication technology. The signal generating and receiving device(s) 1230 may work in conjunction with one or more communication interface(s) 1232 for coupling information to and/or from system 1200. Communication interface 1232 may include a serial port, parallel port, Universal Serial Bus (USB), Ethernet port, Bluetooth, thunderbolt, near field communications port, WiFi, Cellular modem, or other input/output interface. Communication interface 1232 may physically, electrically, optically, or wirelessly (e.g., via radio frequency) couple computer system 1200 with another device, such as a mobile phone, radio, or computer system.

The computing system 1200 is only one example of a suitable computing environment and is not intended to suggest any limitation as to the scope of use or functionality of the present technology. Neither should the computing environment be interpreted as having any dependency or requirement relating to any one or combination of components illustrated in the example computing system 1200.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A system comprising:
a consortium to generate a first set of aggregated customer transaction data for a first plurality of customers,
the first set of aggregated customer transaction data having no personally identifiable information (PII) associated therewith;
a database to maintain a second set of aggregated customer transaction data for a second plurality of customers,
the second set of aggregated customer transaction data having PII associated therewith; and
a transactional data evaluator to:
receive the first set of aggregated customer transaction data and the second set of aggregated customer transaction data;
compare the first set of aggregated customer transaction data with the second set of aggregated customer transaction data;
determine a match between a plurality of customers in the first set of aggregated customer transaction data and the plurality of customers in the second set of aggregated customer transaction data;
combine, based on the match, the first set of aggregated customer transaction data with the second set of aggregated customer transaction data to form a plurality of customer wallets,
each of the plurality of customer wallets representing a specific customer from the plurality of customers, and
each of the plurality of customer wallets having PII associated therewith;
obtain, using the PII, one or more customer metrics for each of the plurality of customer wallets; and
generate, based on an evaluation of the plurality of customer wallets in combination with the one or more customer metrics, a customer behavior presentation for the plurality of customers for a retailer.

2. The system of claim 1 further comprising:
a graphic user interface (GUI) to provide the customer behavior presentation for the plurality of customers to the retailer in a visual format.

3. The system of claim 1 wherein the one or more customer metrics comprise:
a first distance, the first distance being from a home of each of the plurality of customers to the retailer;
a second distance, the second distance being from a work location of each of the plurality of customers to the retailer;
a third distance, the third distance being from a work location of each of the plurality of customers to at least one competitor of the retailer; and
a fourth distance, the fourth distance being from the work location of each of the plurality of customers to the at least one competitor of the retailer.

4. The system of claim 3 wherein the one or more customer metrics further comprise:
a first amount of money spent, by each of the plurality of customers, at the retailer for a given time period; and
a second amount of money spent, by each of the plurality of customers, at one or more of the at least one competitor of the retailer for the given time period.

5. The system of claim 1 wherein the one or more customer metrics further comprise:
a percentage of transactions, for each of the plurality of customers, that occurred at a brick-and-mortar store.

6. The system of claim 5 wherein the transactional data evaluator is further to:
assign, based on an evaluation of the plurality of customer wallets in combination with the one or more customer metrics and the percentage of transactions, for each of the plurality of customers, that occurred at the brick-and-mortar store, each of the plurality of customers to a group selected from the groups consisting of:
a larger than average spender at the brick-and-mortar store;
an average spender at the brick-and-mortar store; or
a less than average spender at the brick-and-mortar store; and
provide the group assignment, for each of the plurality of customers, in the customer behavior presentation.

7. The system of claim 1 wherein the one or more customer metrics further comprise:
a percentage of transactions, for each of the plurality of customers, that occurred online.

8. The system of claim 7 wherein the transactional data evaluator is further to:
assign, based on an evaluation of the plurality of customer wallets in combination with the one or more customer metrics and the percentage of transactions, for each of the plurality of customers, that occurred online, each of the plurality of customers to a group selected from the groups consisting of:
a larger than average online spender;
an average online spender; or
a less than average online spender; and
provide the group assignment, for each of the plurality of customers, in the customer behavior presentation.

9. The system of claim 1 wherein the one or more customer metrics further comprise:
a customer captivity rating for each of the plurality of customers.

10. The system of claim 9 wherein the customer captivity rating is based on a percentage of a total amount of the customer wallet spent in a field of the retailer, which is spent at the retailer.

11. The system of claim 9 wherein the customer captivity rating is based on a percentage of a total amount of the customer wallet, which is spent at the retailer.

12. The system of claim 1 wherein the consortium is further to:
receive a first credit account transactional data set from a first credit account provider;
receive at least a second credit account transactional data set from at least a second credit account provider; and
combine the first credit account transactional data set and the second credit account transactional data set to form the first set of aggregated customer transaction data for the first plurality of customers.

13. The system of claim 12 wherein the consortium is further to:
receive identification information for each transaction in said first credit account transactional data set and said second credit account transactional data set,
the identification information identifying a specific account without providing any PII; and
group any transactions having matching identification information into one or more generic customer accounts.

14. The system of claim 13 wherein the consortium is further to:
review each transaction within the one or more generic customer accounts of the aggregated customer transactional data to determine that at least two generic customer accounts are related to a single generic customer; and
combine the at least two generic customer accounts into a credit account portfolio assigned to the single generic customer.

15. A non-transitory computer-readable medium storing instructions, the instructions comprising:
one or more instructions that, when executed by one or more processors, cause the one or more processors to:
generate a first set of aggregated customer transaction data for a first plurality of customers,
the first set of aggregated customer transaction data having no personally identifiable information (PII) associated therewith;
receive a second set of aggregated customer transaction data for a second plurality of customers,
the second set of aggregated customer transaction data having PII associated therewith;
compare the first set of aggregated customer transaction data with the second set of aggregated customer transaction data;
determine a match between a plurality of customers in the first set of aggregated customer transaction data and the plurality of customers in the second set of aggregated customer transaction data;
combine, based on the match, the first set of aggregated customer transaction data with the second set of aggregated customer transaction data to form a plurality of customer wallets,
each of the plurality of customer wallets representing a specific customer from the plurality of customers, and
each of the plurality of customer wallets having PII associated therewith;
obtain, using the PII, one or more customer metrics for each of the plurality of customer wallets, the one or more customer metrics; and
generate, based on an evaluation of the plurality of customer wallets in combination with the one or more customer metrics, a customer behavior presentation for a retailer.

16. The non-transitory computer-readable medium of claim 15, where the one or more instructions, when executed by the one or more processors, further cause the one or more processors to:
present the customer behavior presentation to the retailer in a visual format on a graphical user interface.

17. The non-transitory computer-readable medium of claim 15, where the one or more customer metrics comprise:
a first distance, the first distance being from a home of each of the plurality of customers to the retailer;
a second distance, the second distance being from a work location of each of the plurality of customers to the retailer;
a third distance, the third distance being from a work location of each of the plurality of customers to at least one competitor of the retailer; and
a fourth distance, the fourth distance being from the work location of each of the plurality of customers to the at least one competitor of the retailer.

18. The non-transitory computer-readable medium of claim 17, where the one or more customer metrics further comprise:
a percentage of transactions, for each of the plurality of customers, that occurred at a brick-and-mortar store; and
where the one or more instructions, when executed by the one or more processors, further cause the one or more processors to:
assign, based on an evaluation of the plurality of customer wallets in combination with the one or more customer metrics and the percentage of transactions, for each of the plurality of customers, that occurred at the brick-and-mortar store, each of the plurality of customers to a group selected from the groups consisting of:
a larger than average spender at the brick-and-mortar store;
an average spender at the brick-and-mortar store; or
a less than average spender at the brick-and-mortar store; and
provide the group assignment, for each of the plurality of customers, in the customer behavior presentation.

19. The non-transitory computer-readable medium of claim 17, where the one or more customer metrics further comprise:
a percentage of transactions, for each of the plurality of customers, that occurred online; and
where the one or more instructions, when executed by the one or more processors, further cause the one or more processors to:
assign, based on an evaluation of the plurality of customer wallets in combination with the one or more customer metrics and the percentage of transactions, for each of the plurality of customers, that occurred online, each of the plurality of customers to a group selected from the groups consisting of:
a larger than average online spender;
an average online spender; or
a less than average online spender; and
provide the group assignment, for each of the plurality of customers, in the customer behavior presentation.

20. The non-transitory computer-readable medium of claim 17, where the one or more instructions, when executed by the one or more processors, further cause the one or more processors to:
determine a customer captivity rating for each of the plurality of customers,
the customer captivity rating selected from the group consisting of: a percentage of a total amount of the customer wallet spent in a field of the retailer, which is spent at the retailer, and a percentage of a total spent amount of the customer wallet, which is spent at the retailer.
